(19) United States
(12) Patent Application Publication
(10) Pub. No.: US 2026/0170967 A1
(43) Pub. Date: Jun. 18, 2026

(54) Attention-Promotion Device and Application System therewith

(71) Applicant: National Tsing Hua University, Hsinchu (TW)

(72) Inventors: Hui-Yu HSU, Hsinchu (TW); Tsu-Jen DING, Hsinchu (TW)

(21) Appl. No.: 19/072,228

(22) Filed: Mar. 6, 2025

(30) Foreign Application Priority Data
Dec. 13, 2024 (TW) 113148666

(51) Int. Cl. G09B 5/02; G06F 3/01

(52) U.S. Cl. CPC G09B 5/02; G06F 3/015

(57) ABSTRACT

An attention-promotion device and a system of a task capable of promoting attention are provided herein. The attention-promotion device includes a unit of frequency generation for providing plural specific first frequency signals which at least include frequencies of 12 Hz, 14 Hz, 19 Hz, 20˜22 Hz, 22 Hz and 38˜40 Hz; a processing-and-controlling unit which receives the plural frequency signals and generates plural visual control instructions according to the plural frequency signals; and plural visual mediums electrically coupled to the processing-and-controlling unit and emitting visible light in those frequencies in response to the visual control instructions.

### CROSS REFERENCE

This application claims priority to Taiwan patent application No. 113148666 filed on Dec. 13, 2024, titled as “Device for Attention Promotion and Application System therewith”, all of which are incorporated by reference herein in its entirety.

### FIELD OF THE INVENTION

This present invention relates to the field of system for task cultivating and training, particularly relates to a system for education and rehabilitation tasks with attention promotion.

### BACKGROUND OF THE INVENTION

Spatial perception is an ability capable of being aware of a relationship between his/her own and ambient environment, which includes knowing the relationship as two objects'spatial positions change, observing objects from different views and identifying them. The development of spatial perception may be affected by the development of some diseases, such as autism, Asperger's syndrome, cerebral palsy and other diseases, and some situations may happen including lack of knowing one's own body, being aware of spatial perception for one's own body and difficulty in viewing one's own body as a whole.

Besides, the human left cerebral hemisphere where mathematical and spatial calculation are processed, dominates the development of spatial perception and directly relates to being aware of one's own spatial perception on environment and cognizing space. Provided that the human left cerebral hemisphere is affected by stroke and traumatic brain injury on specifical zones of brain, the capability of positioning and cognizing directions will be also affected, as well as spatial perception. Furthermore, there are some approaches to recover or improve spatial perception, such as daily training, professional training, and adjustment on living habits, that may be gradually and lasting executed via different ways.

### SUMMARY OF THE INVENTION

An attention-promotion device and a system of tasks and attention promotion therewith are provided. Visible light emitted from the attention-promotion device is of frequency or frequency band for attention promotion, which may be incident into area within a viewer's view of field to cooperate with the execution of a cultivation software for improving spatial cognition. The visible light of the specific frequency or frequency band would be beneficial to the viewer's stability and concentration promotion at the same time of executing the cultivation software for the viewer.

An attention-promotion device and a system of tasks and attention promotion therewith are provided to be implemented on site of in-practice education and rehabilitation, as well as virtual classrooms of VR (virtual reality) and AR (augmented reality). The beta frequency wave in the viewer as well as learning efficiency may increase with the use of the attention-promotion device during the execution of education and rehabilitation software.

An attention-promotion device and a system of tasks and attention promotion therewith are provided to apply onto a user with obstacle on using voluntary muscles. Visual stimulus of specific frequency band may contribute to a viewer's attention to raise more interaction between the viewer and the executing the cultivation software, as well as learning effects.

Accordingly, an attention-promotion device includes: a frequency-generating unit outputting plural frequency signals, wherein the frequency signals have first frequencies including 12 Hz, 14 Hz, 19 Hz, a first range between 20 Hz and 22 Hz, 22 Hz, and a second range between 38 Hz and 40 Hz; a processing-and-controlling unit electrically coupling with the frequency-generating unit, the processing-and-controlling unit receiving the frequency signals and generating plural visual controlling instructions according to the frequency signals; and plural visual mediums electrically coupling to the processing-and-controlling unit, the visual medium emitting visible light with at least one of the first frequencies.

Accordingly, a system of tasks and attention promotion includes: a frequency-generating unit outputting plural frequency signals, wherein the frequency signals have first frequencies including 12 Hz, 14 Hz, 19 Hz, a first range between 20 Hz and 22 Hz, 22 Hz, and a second range between 38 Hz and 40 Hz; a task stimulating and controlling block electrically coupling with the frequency-generating unit, the task stimulating and controlling block receiving the frequency signals and executing an education and rehabilitation software, wherein the task stimulating and controlling block comprises a processing-and-controlling unit generating plural visual controlling instructions corresponding to the frequency signals; and a human-computer visual interface electrically coupling to the task stimulating and controlling block, wherein the human-computer visual interface displays a visual screen of the education and rehabilitation software executed by the task stimulating and controlling block, and emits visible light with at least one of the first frequencies.

In one embodiment, the frequency signals further have second frequencies including at least one of 23 Hz, 25 Hz and 31 Hz.

In one embodiment, the visual mediums include plural light indicators or are integrated into an indicating display.

In one embodiment, a human-computer input unit is electrically coupled to the task stimulating and controlling block, wherein the human-computer input unit provides a viewer to input a control instruction to the system of tasks and attention promotion.

In one embodiment, an electroencephalography-capturing device and an electroencephalography-processing device are further included, wherein the electroencephalography-capturing device is electrically coupled with the electroencephalography-processing device, and the electroencephalography-processing device is electrically coupled to the task stimulating and controlling block.

In one embodiment, a part of the visual screen displayed by the human-computer visual interface corresponds to plural color blocks with the visible light with the first frequencies.

In one embodiment, the color blocks are used for a user to input a control instruction therewith for the education and rehabilitation software.

In one embodiment, the frequency-generating unit further outputs the frequency signals of plural second frequencies, and the second frequencies comprise at least one of 23 Hz, 25 Hz, and 31 Hz.

In one embodiment, the human-computer visual interface comprises plural light indicators, and the light indicators emit the visible light with at least one of the first frequencies.

In one embodiment, the human-computer visual interface further includes a display panel displaying the visual screen of the education and rehabilitation software executed by the task stimulating and controlling block.

### BRIEF DESCRIPTION OF THE DRAWINGS

FIG. 1 is a schematic block diagram illustrating a first example of a attention-promotion device in accordance with the present invention.

FIG. 2 is a schematically first physical diagram illustrating the device in FIG. 1.

FIG. 3 is a schematically second physical diagram illustrating the device in FIG. 1.

FIG. 4 is a schematically third physical diagram illustrating the device in FIG. 1.

FIG. 5 is a schematic block diagram illustrating a first example of an application system with the attention-promotion device in accordance with the present invention.

FIG. 6 is a schematic block diagram illustrating a second example of an application system with the attention-promotion device in accordance with the present invention.

FIG. 7 is a schematic block diagram illustrating a third example of an application system with the attention-promotion device in accordance with the present invention.

FIG. 8 is a schematic block diagram illustrating a fourth example of an application system with the attention-promotion device in accordance with the present invention.

FIG. 9 is a schematic block diagram illustrating a fifth example of an application system with the attention-promotion device in accordance with the present invention.

FIG. 10 is a schematic block diagram illustrating a sixth example of an application system with the attention-promotion device in accordance with the present invention.

FIG. 11 is a schematic block diagram illustrating a seventh example of an application system with the attention-promotion device in accordance with the present invention.

### DETAILED DESCRIPTION OF THE PREFERRED EMBODIMENT

In the present invention, cultivation means education or rehabilitation or both, and a cultivation system, a cultivation package software, a cultivation kit may be used in real fields or virtual fields. The virtual fields may be built with virtual reality (VR), augmented reality (AR), or combining both.

In the present invention, a frequency-generating unit is configured to generate signals of specific frequencies and waveforms, which may include oscillator, frequency synthesizer, waveform shaper, amplifier, output buffer and control circuit, etc. The frequency-generating unit may be implemented by one or more modules, single or multitude members, members and modules integrated into a single device or deposited in different devices. The frequency-generating unit may be one kind of, for example but not limited to, signal generator, function generator or arbitrary waveform generator. In the present invention, the frequency-generating unit may output signals having a first frequency of 12 Hz, 14 Hz, 19 Hz, a first range between 20 Hz and 22 Hz, 22 Hz, a second range between 38 Hz and 40 Hz, or the combination thereof. The signals from the frequency-generating unit may additionally have a second frequency of 23 Hz, 25 Hz, 31 Hz, or the combination thereof. In the present invention, the frequency-generating unit may be used to induce a viewer with signals to have visual stimulation for generating steady-state visual evoked potentials (SSVEP).

In the present invention, a visual medium emits specific visual stimulus in response to the signals generated by the frequency-generating unit. The specific visual stimulus may be in the form of visible light with color, brightness, frequency of continuously or periodically flashing. The visual medium, for example but not limited to, may be one kind of a single light indicator, a light indicator integrated into a device, one or more visual blocks combined into a display screen, etc.

In the present invention, a processing unit or a controlling unit may include processers, control and peripheral circuits in a local electric device. A controlling unit may further include parts capable of calculating, computing, or analyzing provided by a cloud servo or servos. That is, tasks relevant to processing, computing and analyzing may be implemented or executed by local real device/equipment together with cloud services or only local real device/equipment.

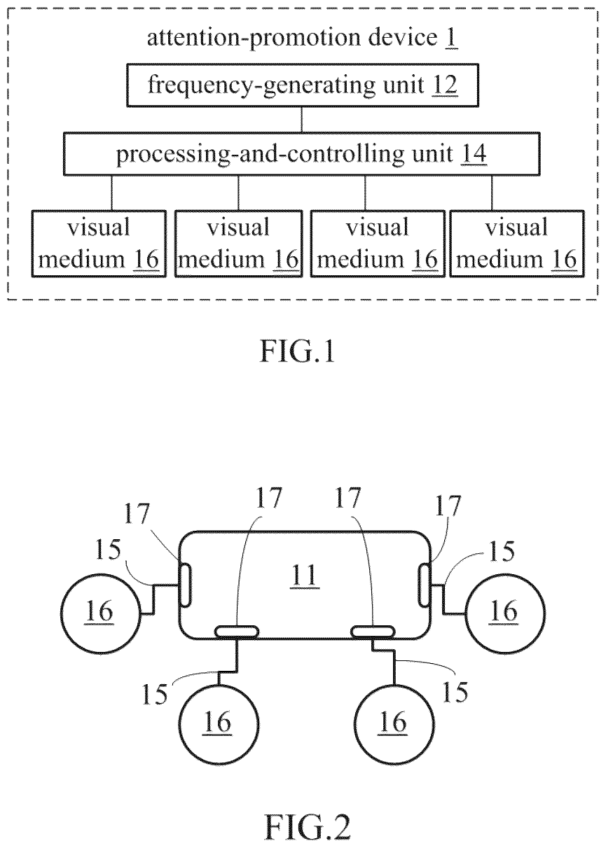

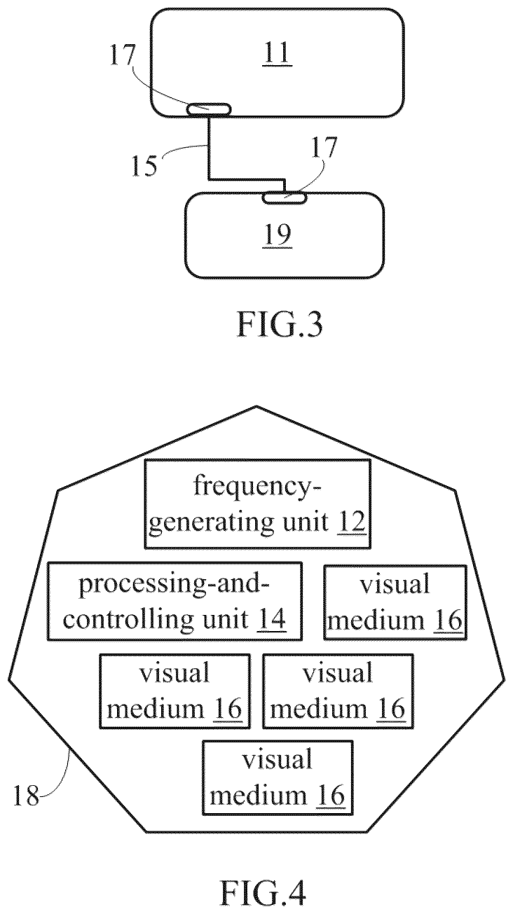

FIG. 1 is a schematic block diagram illustrating a first example of an attention-promotion device in accordance with the present invention. FIG. 2 is a schematically first physical diagram illustrating the device in FIG. 1. FIG. 3 is a schematically second physical diagram illustrating the device in FIG. 1. FIG. 4 is a schematically third physical diagram illustrating the device in FIG. 1. Please refer to FIG. 1, FIG. 2, FIG. 3 and FIG. 4. An attention-promotion device 1 at least includes a frequency-generating unit 12, a processing-and-controlling unit 14 and plural visual mediums 16. In the first embodiment, the frequency-generating unit 12 coupled with the processing-and-controlling unit 14 outputs one or more frequency signals to the processing-and-controlling unit 14. Next, the processing-and-controlling unit 14 coupled with the plural visual mediums 16 generates one or more visual control instructions according to the received frequency signals. The plural visual mediums 16 may output specific visual stimulus in response to the corresponding visual control instructions. For requirement, the attention-promotion device 1 may optionally further include a storage unit (not shown in figures), such as memory for storing firmware, software and signals for the attention-promotion device 1. The attention-promotion device 1 may optionally further include a power providing unit (not shown in figures), such as batteries for providing power to the attention-promotion device 1. Next, in the first embodiment, the frequency-generating unit 12 may output signals having at least one of a first frequency of 12 Hz, 14 Hz, 19 Hz, a first range between 20 Hz and 22 Hz, 22 Hz, a second range between 38 40 Hz, or the combination thereof. The frequency-generating unit 12 may additionally output signals having at least one of a second frequency of 23 Hz, 25 Hz, 31 Hz, or the combination thereof. The processing-and-controlling unit 14 generates the corresponding visual control instructions to make the plural visual mediums 16 respectively emit color visible light with the corresponding specific frequency or frequency range. In the case of depositing the attention-promotion device 1 within a viewer's field of view, visible light emitted from the attention-promotion device 1 may be received, conscious and noticed by the viewer, and beneficial to promote the viewer's attention.

Please continually refer to FIG. 1, FIG. 2, FIG. 3 and FIG. 4. In practice in FIG. 1 and FIG. 2, the frequency-generating unit 12 and the processing-and-controlling unit 14 are deposited in a single housing 11, the plural visual mediums 16 are separated light indicators 13, and the single housing 11 couples to the separated light indicators 13 via connecting lines 15 (wires or cables). There may be some coupling ports 17 on the housing 11 for plugging and unplugging the connecting wires 15. It is understood that there may be some coupling ports (not shown) on the light indicators 13 for plugging and unplugging the connecting wires 15, too. Alternatively, please refer to FIG. 1 and FIG. 3, the frequency-generating unit 12 and the processing-and-controlling unit 14 are deposited in a single housing 11, the plural visual mediums 16 are integrated into an indicating display panel 19, and the housing 11 and the indicating display panel 19 may couple each other with the connecting wires 15. It is also understood that there are some coupling ports on the housing 11 or the indicating display panel 19, too. Besides, there are some fixing designs or fixing slots on the housing 11 for mounting the indicating display panel 19. Alternatively, please refer to FIG. 1 and FIG. 4, the frequency-generating unit 12, the processing-and-controlling unit 14 and the plural visual mediums 16 may be integrated into a single housing 18. The shape of the housing 18, for example but not limited to, cube, polygon, flat plate or flexible curve body.

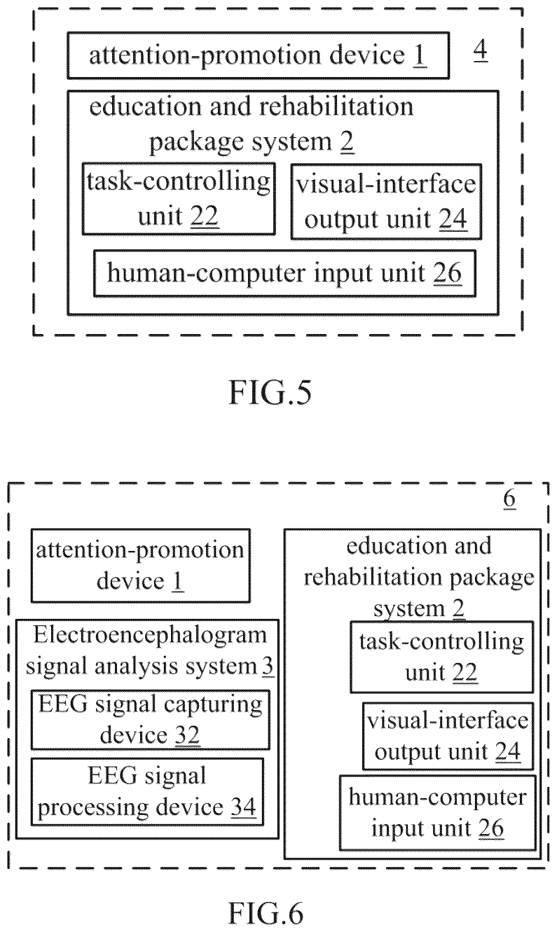

FIG. 5 is a schematic block diagram illustrating a first example of an application system with the attention-promotion device in accordance with the present invention. Please refer to FIG. 1, FIG. 2, FIG. 3, FIG. 4 and FIG. 5. In the present invention, a system of tasks and attention promotion 4 includes the attention-promotion device 1 and an education and rehabilitation package system 2. In the embodiment, the education and rehabilitation package system 2 at least includes a task-controlling unit 22, a visual-interface output unit 24 and a human-computer input unit 26. The task-controlling unit 22 stores, processes, analyzes and executes cultivation (education/rehabilitation) software, which may include a computer with processors and memories and the software installed in the computer. Next, the cultivation (education/rehabilitation) software may be a package kit relevant to games or educational materials for cognitive activities of spatial perception. The package kit may be stored in a computer-accessible suitable medium and include a computer program stored in the computer-accessible suitable medium. The visual-interface output unit 24 at least provides a viewer visual screens in the visual form, and the visual screens are shown based on the execution of the cultivation (education/rehabilitation) software. The visual-interface output unit 24 includes, for example but not limited to, a sole liquid crystal display, display panel, or a display interface of an electrical equipment. The display interface of an electrical equipment may be the one of a head-mounted display or equipment. The human-computer input unit 26 provides the viewer with a device for inputting control instructions, such as keyboard, mouse, joystick, remote control, or rocker. In the embodiment, the attention-promotion device 1 and the education and rehabilitation package system 2 may respectively and independently execute. The plural visual mediums 16 of the attention-promotion device 1 may be implemented in the forms of the light indicators 13 or the indicating display panel 19, and the light indicators 13 or the indicating display panel 19 may be deposited around the visual-interface output unit 24 within the viewer's view of field. The viewer, an ADHD (attention deficit hyperactivity disorder) patient for example, may conduct education or rehabilitation by interacting with the education and rehabilitation package system 2, and improve stability and attention via the color light with the specific frequencies captured by the viewer's eyes at the same time.

FIG. 6 is a schematic block diagram illustrating a second example of an application system with the attention-promotion device in accordance with the present invention. Please refer to FIG. 1, FIG. 2, FIG. 3, FIG. 4 and FIG. 6, a system of tasks and attention promotion 6 includes the attention-promotion device 1, the education and rehabilitation package system 2 and an electroencephalogram signal analysis system 3. In the embodiment, the attention-promotion device 1 and the education and rehabilitation package system 2 shown in FIG. 6 may correspond to the system of tasks and attention promotion 4 shown in FIG. 5, so it is not repeatedly illustrated here. The electroencephalogram signal analysis system 3, such as a brain-computer interface (BCI) system, at least includes an electroencephalogram signal capturing device (EEG signal capturing device) 32 and an EEG signal processing device 34. The EEG signal capturing device 32 that may include plural electrodes for capturing scalp potentials captures the viewer's electroencephalogram signals, during a visual stimulation period provided by the attention-promotion device 1 and the execution of the education and rehabilitation package system 2. The EEG signal processing device 34 includes plural elements, components, circuits and processors that process the electroencephalogram signals captured by the EEG signal capturing device 32. The process for electroencephalogram signals may be to, for example but not limited to, amplify electroencephalogram signals, filter electroencephalogram signals, record electroencephalogram signals and store electroencephalogram signals. In the embodiment, the color lights with the specific frequencies from the light indicators 13 or the indicating display panel 19 may enter the viewer's eyes during the execution of the education and rehabilitation package system 2, and the electroencephalogram signal analysis system 3 may capture the viewer's electroencephalogram signals to analyze and evaluate the effects or degrees of stability and attention promotion.

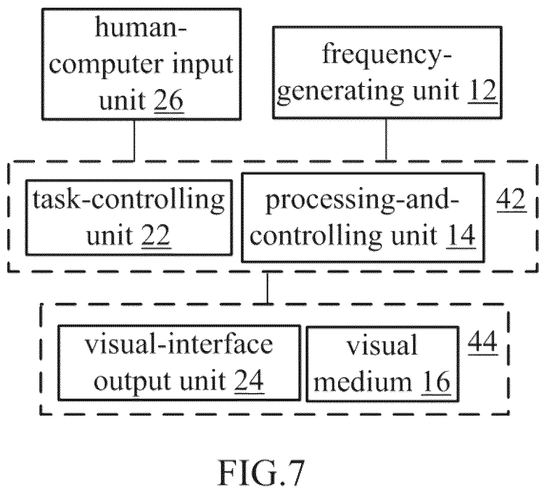

FIG. 7 is a schematic block diagram illustrating a third example of an application system with the attention-promotion device in accordance with the present invention. Please refer to FIG. 1, FIG. 2, FIG. 3, FIG. 4, FIG. 5 and FIG. 7. Compared with FIG. 5, a system of tasks and attention promotion shown in FIG. 7 integrates the attention-promotion device together with the execution of the education and rehabilitation package system. Shown in FIG. 7, a task and stimulus control block 42 may include the task-controlling unit 22 and the processing-and-controlling unit 14, and a human-computer visual interface 44 includes the visual-interface output unit 24 and the visual medium 16. In the embodiment, the frequency-generating unit 12 outputs one or more frequency signals to the task and stimulus control block 42, and the task and stimulus control block 42 may integrate the execution of the education and rehabilitation software with the visual control instructions, such as the arrangement of executing time sequences for both. The human-computer visual interface 44, such as a single display panel, may display the color lights of the visual medium 16 in advance or just in time thereon during displaying screens under the execution of the education and rehabilitation software. Accordingly, both the displaying screens under the execution of the education and rehabilitation software and the color lights with the specific frequencies are shown on the same display panel, which may promote the viewer's stability and attention, too. Furthermore, the task and stimulus control block 42 may coordinate the execution of education and rehabilitation software and the visual control instructions, according to the states of the human-computer input unit 26. An imaginary scenario is, when the viewer does not pay attention to interacting with the executing education and rehabilitation software, the human-computer input unit 26 turns into a sleep or an idle state due to no action therewith in time. In the case of the human-computer input unit 26 in sleep or idle state, the task and stimulus control block 42 may adjust or change the displaying visual medium 16, such as flashing or brightening, for attracting the viewer to reconcentration. It is understood that the visual-interface output unit 24 and the visual medium 16, both controlled by the task and stimulus control block 42, may divide into different display or indicating device to respectively display in corresponding sequences and ways.

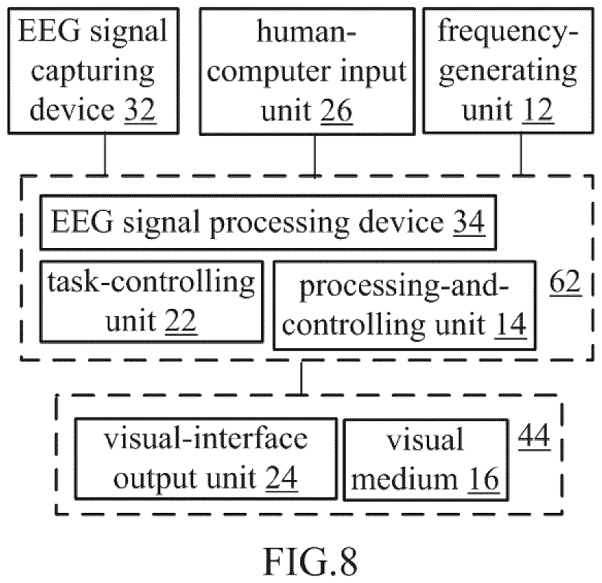

FIG. 8 is a schematic block diagram illustrating a fourth example of an application system with the attention-promotion device in accordance with the present invention. Please refer from FIG. 1 to FIG. 8. Compared with FIG. 6 and FIG. 7, a task and stimulus control block 62 shown in FIG. 8 includes the task-controlling unit 22, the processing-and-controlling unit 14 and the EEG signal processing device 34. The task and stimulus control block 62 may process and analyze the respective inputs from the frequency-generating unit 12, the human-computer input unit 26 and the EEG signal capturing device 32, and judge with all of them. Thus, the task and stimulus control block 62 may control the displaying screens by the education and rehabilitation software in execution and the color lights by the visual medium 16. In the embodiment, during the interaction between the viewer and the education and rehabilitation software in execution, the EEG signal capturing device 32 may in-time or periodically capture the viewer's EEG signals and transfer them to the task and stimulus control block 62 for processing, analyzing and judgement. Thus, it is beneficial to comprehensively understand and evaluate the viewer's education/rehabilitation condition, attention and concentration promotion.

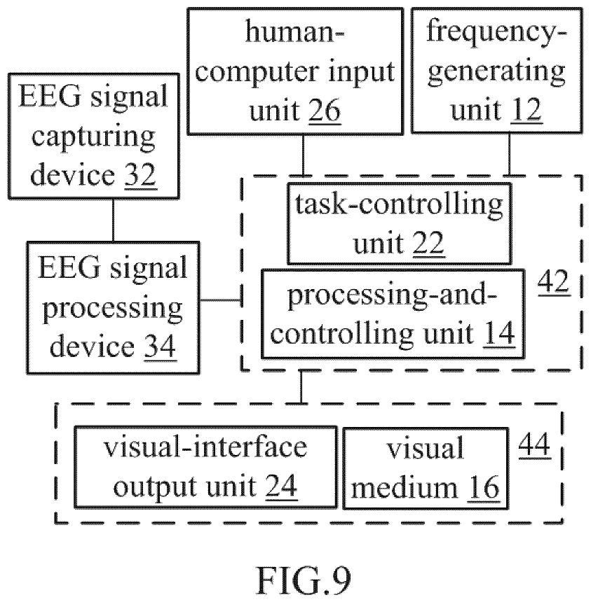

FIG. 9 is a schematic block diagram illustrating a fifth example of an application system with the attention-promotion device in accordance with the present invention. Compared with FIG. 7, the capturing and processing of EEG signal are integrated into the attention-promotion device in the embodiment shown in FIG. 9. The results acquired from the EEG signal processed, calculated and analyzed by the EEG processing device 34 may further be considered by the task and stimulus control block 42 to do an integrating evaluation, so as to bring a comprehensive understanding about the attention and concentration promotion degree of the viewer, as well as the education/rehabilitation condition. Alternatively, the task and stimulus control block 42 may contribute to the frequency-generating unit 12 via the processing-and-controlling unit 14 according to the result of the EEG signal.

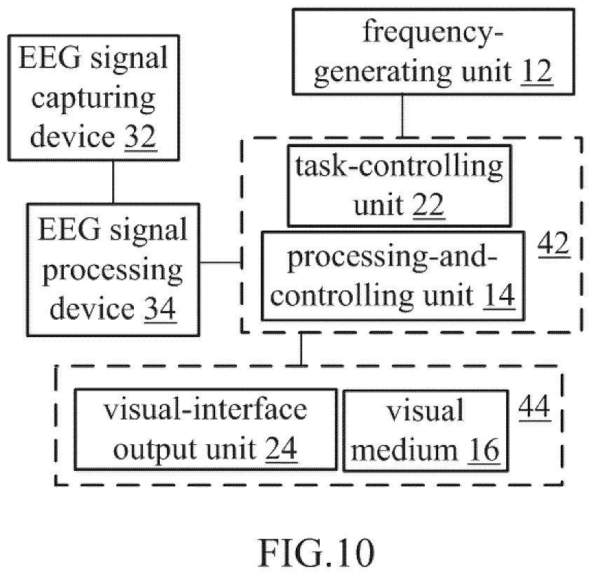

FIG. 10 is a schematic block diagram illustrating a sixth example of an application system with the attention-promotion device in accordance with the present invention. In addition of attention promotion, it is beneficial for a user who is unable to freely use his/her own voluntary muscles by his/her own mind, such as muscle paralysis or cerebral palsy patient, to express his/her decision with the help of the visual mediums with the attention-promotion device. Please refer to FIG. 7, FIG. 8, FIG. 9 and FIG. 10. Compared with the earlier embodiments, in the case of the user unable or fail to input control instructions with the human-computer input unit 26, the visual mediums 16 of the present invention may be as a human-computer input unit for the user to input control instructions. An application scenario for FIG. 10 is, the visual medium 16 may be displayed in the form of color blocks along with the screens of the education and rehabilitation software in execution. When a request shown on the screen of the education and rehabilitation software in execution asks for the user to input instructions, such as asking for the user to determine one of answers from multiple choice questions, these answers may be together with or joined into the color blocks of the visual mediums 16. The user may choose one target answer by fixing on one color block corresponding to the target answer. On the other hand, whether the user fixes on the color blocks of the visual medium 16 or which one color block is watched by the user may be understood through the analysis of the EEG signal capturing device 32 and the EEG processing device 34. Thus, even without additional or other human-computer input unit, the user still inputs control instructions through focusing on the color blocks of the visual medium 16.

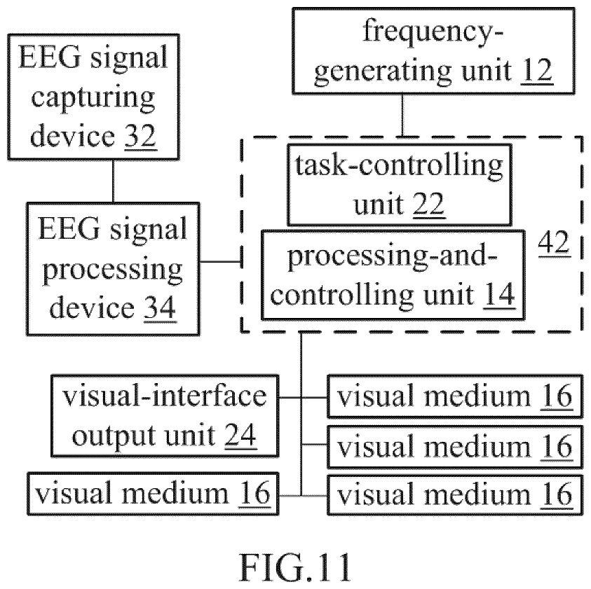

Please continuously refer to FIG. 10. For various human-computer input units for different purposes, multiple visual mediums 16 are preferably used as the human-computer input unit. Each of the visual mediums 16 may display the color block with one of the specific first frequencies, and the color lights of the specific first frequencies corresponding to the color blocks do not interfere with each other. Thus, the EEG signal capturing device 32 and the EEG processing device 34 perform correct analysis on the captured EEG signal which reflects the decision made by the user. Besides, the multiple visual mediums 16 may display the color block with one of the specific second frequencies as well as the specific first frequencies, and the color lights of the specific first and second frequencies corresponding to the color blocks do not interfere with each another. It is understood that the visual medium 16 shown in FIG. 10 may be applied to the architecture shown in FIG. 8. FIG. 11 is a schematic block diagram illustrating a seventh example of an application system with the attention-promotion device in accordance with the present invention. Compared with FIG. 10, there are visual mediums 16 separative from the visual-interface output unit 24 in FIG. 11, for example but not limited to, the visual-interface output unit 24 is a single display panel, and the multiple visual mediums 16 of light indicator are deposited around or at one side of the single display panel. When the visual-interface output unit 24 displays the screens of the education and rehabilitation software in execution and the user is asked for to make an answer, there may be indication shown on the screen to guild the user to use the visual mediums for inputting. The visual mediums 16 may be light indicators with showing numerals, and the indication shown on the screen may guild the user to focus on one of the numerals shown on the corresponding visual medium 16 for answer. Such a attention-promotion device in accordance with the present invention may have human-computer input function and apply to the same.

The above description is merely exemplary of the preferred embodiments of the present invention and should not be construed as limiting the scope of the invention. Any modifications, equivalents, substitutions, or improvements made within the spirit and principles of the present invention should be encompassed within the scope of protection of the invention.

What is claimed is:

1. An attention-promotion device, comprising:
a frequency-generating unit outputting plural frequency signals, wherein the frequency signals have first frequencies including 12 Hz, 14 Hz, 19 Hz, a first range between 20 Hz and 22 Hz, 22 Hz, and a second range between 38 Hz and 40 Hz;
a processing-and-controlling unit electrically coupling with the frequency-generating unit, the processing-and-controlling unit receiving the frequency signals and generating plural visual controlling instructions according to the frequency signals; and
plural visual mediums electrically coupling to the processing-and-controlling unit, the visual medium emitting visible light with at least one of the first frequencies.

2. The attention-promotion device according to claim 1, wherein the frequency signals further have second frequencies including at least one of 23 Hz, 25 Hz and 31 Hz.

3. The attention-promotion device according to claim 2, wherein the visual mediums comprise plural light indicators.

4. The attention-promotion device according to claim 2, wherein the visual mediums are integrated into an indicating display.

5. The attention-promotion device according to claim 1, wherein the visual mediums comprise plural light indicators.

6. The attention-promotion device according to claim 1, wherein the visual mediums are integrated into an indicating display.

7. A system of tasks and attention promotion, comprising:
a frequency-generating unit outputting plural frequency signals, wherein the frequency signals have first frequencies including 12 Hz, 14 Hz, 19 Hz, a first range between 20 Hz and 22 Hz, 22 Hz, and a second range between 38 Hz and 40 Hz;
a task stimulating and controlling block electrically coupling with the frequency-generating unit, the task stimulating and controlling block receiving the frequency signals and executing an education and rehabilitation software, wherein the task stimulating and controlling block comprises a processing-and-controlling unit generating plural visual controlling instructions corresponding to the frequency signals; and
a human-computer visual interface electrically coupling to the task stimulating and controlling block, wherein the human-computer visual interface displays a visual screen of the education and rehabilitation software executed by the task stimulating and controlling block, and emits visible light with at least one of the first frequencies.

8. The system of tasks and attention promotion according to claim 7, further comprising a human-computer input unit electrically coupled to the task stimulating and controlling block, wherein the human-computer input unit provides a viewer to input a control instruction to the system of tasks and attention promotion.

9. The system of tasks and attention promotion according to claim 7, further comprising an electroencephalography-capturing device and an electroencephalography-processing device, wherein the electroencephalography-capturing device is electrically coupled with the electroencephalography-processing device, and the electroencephalography-processing device is electrically coupled to the task stimulating and controlling block.

10. The system of tasks and attention promotion according to claim 7, wherein a part of the visual screen displayed by the human-computer visual interface corresponds to plural color blocks with the visible light with the first frequencies.

11. The system of tasks and attention promotion according to claim 10, wherein the color blocks are used for a user to input a control instruction therewith for the education and rehabilitation software.

12. The system of tasks and attention promotion according to claim 7, wherein the frequency-generating unit further outputs the frequency signals of plural second frequencies, and the second frequencies comprise at least one of 23 Hz, 25 Hz, and 31 Hz.

13. The system of tasks and attention promotion according to claim 7, wherein the human-computer visual interface comprises plural light indicators, and the light indicators emit the visible light with at least one of the first frequencies.

14. The system of tasks and attention promotion according to claim 13, wherein the human-computer visual interface further comprises a display panel displaying the visual screen of the education and rehabilitation software executed by the task stimulating and controlling block.
Attention-Promotion Device and Application System therewith
